(19) United States
(12) Patent Application Publication
(10) Pub. No.: US 2002/0115488 A1
(43) Pub. Date: Aug. 22, 2002

(54) System and method for conducting an online competition

(76) Inventors: Nicholas Berry, Redmond, WA (US); Lucinda Ann Jones, Woodinville, WA (US); G. Scott Tomlin, Bellevue, WA (US); Dean M. Pachosa, Kenmore, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(21) Appl. No.: 09/789,635

(22) Filed: Feb. 22, 2001

(51) Int. Cl. G06F 17/00

(52) U.S. Cl. 463/42

(57) ABSTRACT

Ranking based online competition system and method in which online game players and sports fans can compete directly with one another and have the results of their games processed into rankings. The competition comprises a season or tour of an extended time duration. Each season or tour is comprised of a number of events or tournaments, which in turn are comprised of one or more rounds or games. The system tracks the results of multiple online events and ranks the players depending on the points they score or the purses they win. The system electronically mimics an actual competition season such as a professional golf tour or a sports season comprised of a number of events. The players are ranked based on the cumulative prizes or points they have won in each of the games. Players need not be entered in all of the events to qualify for an entry on a master scoreboard that displays the rankings of players from the start of the season to a point in time. The top ranked players at the end of the season may be awarded prizes or compete in a finalist championship.

### BACKGROUND OF THE INVENTION

This invention relates to an online competition in which the results of games played online are processed to a master scoreboard that maintains and displays rankings of all of the participants of all games played, and more particularly, to a system and method of receiving, maintaining, processing and outputting information for a plurality of online games for a fixed duration of time or number of events to comprise rankings for a tour or season.

Professional sports are generally divided into playing seasons or tours in which games and tournaments are played. In sports in which prize money is awarded, the amount of money players have won in individual tournaments and during a season are used to calculate rankings or standings based on earnings. Examples of professional sports in which money earnings are used to determine rankings or standings include golf, tennis, bowling and auto racing. Similarly, in some sports, point values are assigned to the winner and subsequent place finishers of individual events, and the cumulative point totals are used to calculate rankings or standings for a given period of time, like a playing season. An example of a sport that calculates rankings in this manner is professional tennis.

In the online gaming environment, players are able to play games or directly participate in virtual sports with one another. Another way that online participants can play games online is through fantasy leagues in which participants select fantasy sports teams of actual professional athletes in a given sport. The fantasy leagues generally operate by comparing the individual sport statistics of the athletes' performances in an actual game. Point systems are used to calculate the winning athletes or teams. While both types of online participation give players a clear sense of winning and losing, neither provides the online game participant with the opportunity to play a game or sport for himself or herself. Moreover, there is no simulation of the experience of a season of play in which the participant is the player instead of tracking the performance of a professional athlete.

Current game systems do not provide a season or tour of play which resembles one that spans a long time interval, allowing the players to choose the events in which they will participate.

### SUMMARY OF THE INVENTION

The present invention is a ranking based competition system in which online game players and sports fans can compete directly with one another and have the results of their games processed into rankings of players who compete in a variable number of games. The system tracks the results of multiple online events and ranks the players depending on the points they score or the purses they win. The system electronically mimics an actual competition season such as a professional golf tour or a sports season comprised of a number of events. The players are ranked based on the cumulative prizes or points they have won in each of the games. Players need not be entered in all of the events to qualify for an entry on a master scoreboard that displays the rankings of players from the start of the season to a point in time.

Once the season or tour information is set-up, no interaction is required and the online competition proceeds automatically. The set-up information includes the dates and times of the events and a predetermined prize structure based on player ranking. A season or tour is comprised of multiple events or tournaments which are scheduled and announced. Each event or tournament is in turn comprised of one or more rounds or games in which individual players enter online within the allotted event time period. Players participate in a round or game, and points are assigned to the players according to how they finished the round. For example, the winner gets the most points or largest purse. The results of the games played online are automatically uploaded to a master score database. The score database receives the results of all of the games upon completion and processes the information to output a ranking of players based on their performances. The prize structure may award the top ranking player and any number of subsequent placers at the end of the season or tournament. The online tournament is conducted over a long period of time, weeks or months, and players participate in the events as they are able. Players do not need to compete in every event to be ranked.

Another aspect of the invention is an administrative site to administer the online events or tournaments. These functions include registration of players, checking for duplicate player entries, regulation of players who have a history of not completing games or of deviating from the rules, creating or editing a tournament, and creation or editing of a prize matrix.

### BRIEF DESCRIPTION OF DRAWINGS

FIG. 1 is a diagram illustrating an overview of the online competition site.

FIG. 2 is a diagram schematically illustrating the data arrangement of the master scoreboard.

FIG. 3 is a schematic diagram of the system hardware.

FIG. 4 is a flow diagram of a player's travel through the online competition.

FIG. 5 is a representation of the game rooms available to players in the online competition.

FIG. 6 is a representation of a tournament time table on the competition site.

FIG. 7 is a representation of a summary page for an event showing course conditions.

FIG. 8 is a representation of a game room.

FIG. 9 is a representation of a leader board for an event that is on-going.

FIG. 10 is a representation of a leader board for an event that has already been completed.

FIG. 11 is a representation of a money board for the online competition.

### DETAILED DESCRIPTION

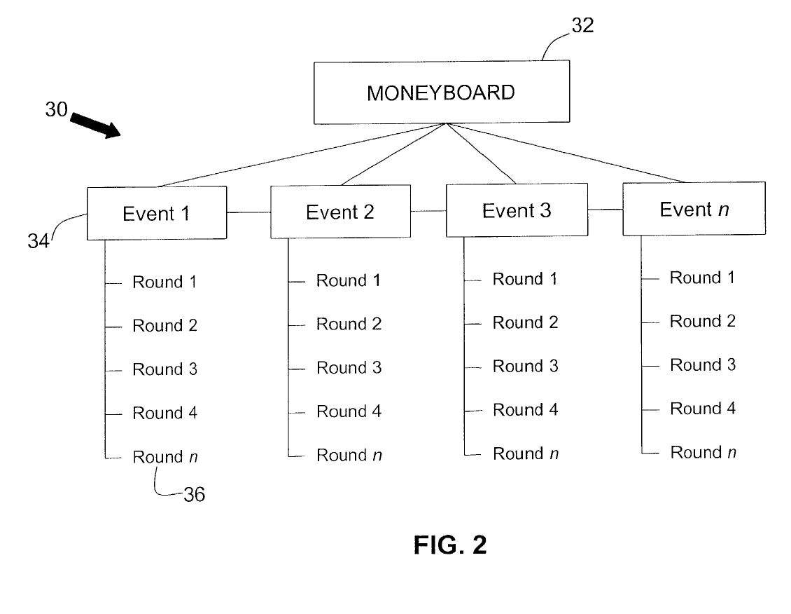

The online competition allows for online participants to play each other directly in a number of events over a period of time and have the results collected and tallied onto an overall master score board. This type of online play simulates an actual sports season or tour (for example, in the case of professional golf, the PGA Tour™). For convenience of description, the following terms will be used interchangeably throughout to refer to the competition from higher level to lower level as follows: a tour or season is the entire online competition for which a master score board or money board is compiled; the tour is comprised of a number of events or tournaments held over predetermined time periods; an event or tournament is comprised of one or more rounds or games, FIG. 2. An embodiment of the invention is based on professional golf's PGA Tour™, and uses terminology most often associated with golf. The golf version of the competition uses purses or money winnings as the point values for winners and runners-up, so that leaders are tracked by their overall earnings on a money board which is equivalent to a master score board. The principles of the invention, however, are applicable to a wide range of sports or games in which point values can be assigned to the winner of a game and any runners up, and rankings compiled from the results.

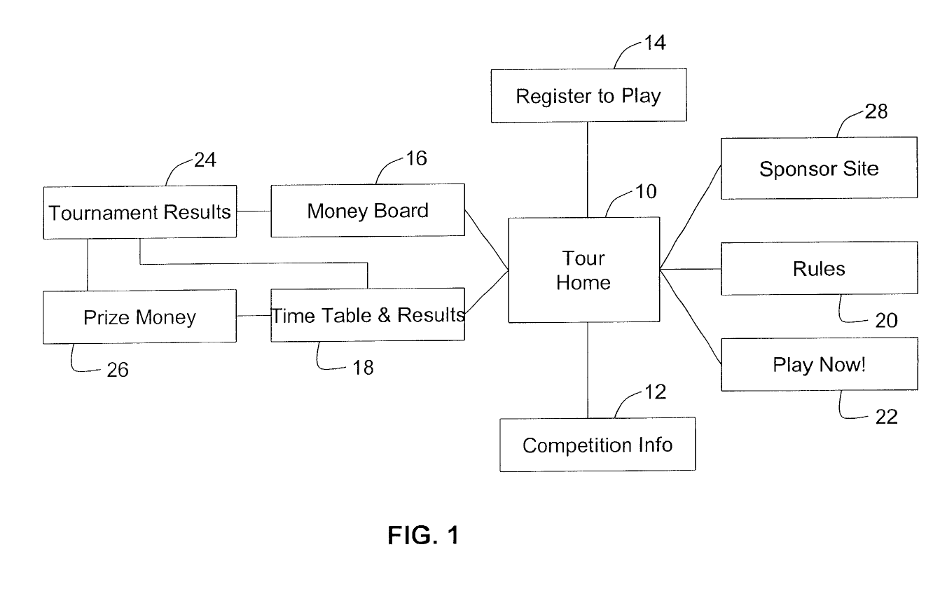

An overview of the online competition site is illustrated in FIG. 1 in which various areas of the site are accessible from a Tour Home 10. These various areas are identified with reference numerals and named by their functions. A participant who enters the tour home site can choose to get review Competition Information 12, Register to Play 14 in the competition, check the Money Board 16 for the overall standings, review the Time Table 18 of events and event results, review the Rules 20 and of course can choose to Play 22. The results of each event can be reviewed in the Tournament Results 24 as well as the Prize Money 26 table for the Tour. Since the online competition can award cash or other prizes at the end of a tour or season, information about the sponsors is available from the site as well as links to Sponsor Sites 28.

An overview of the competition format is illustrated schematically in FIG. 2 in which the entire grouping is a tour or season 30, and the rankings of the participants are listed in a master scoreboard or money board 32. The tour is divided into a number of events or tournaments 34, which in turn each comprise one or more rounds or games 36. The number of players who can participate in any one round or game is not limited but can be pre-determined. For a golf competition, for example, the number of players in a round or game is generally limited to no more than four. The results of the events are used to determine a ranking of participants based on the points they have accumulated or money they have earned. The ranking is the output on the master scoreboard/money board.

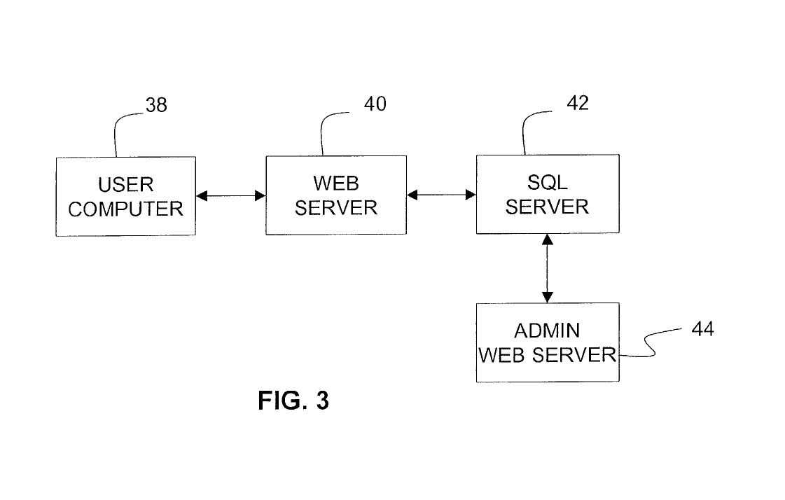

The hardware requirements for the online competition are illustrated schematically in FIG. 3. A user computer 38 with Internet access is the user interface portion of the competition, and must have appropriate software available locally for electronic play, if such software is required. The competition may also be run entirely as a web-based game. The competition is presented and managed by a web server 40 for navigation and data presentation. The web server 40 communicates with a database, in this case, a Structured Query Language (SQL) server 42 which is capable of performing a number of stored procedures with data from the web server 40. The SQL server 42 also contains the tour and event schedules, the rankings tables and the rankings processor. One of the procedures the SQL server 42 performs is to check for incomplete rounds or duplicate entries in rounds. In communication with the SQL server 42 is an administrative web server 44 which checks for participant compliance with the rules of the competition, administers player registration information, controls the open and close of events according to the schedule and can disqualify a player during the competition.

When a competition is created, a tour coordinator creates a structure which includes the schedule for the events, the number of events, any limitations on the rounds and the prize structure. Using an administrative tool 44, these parameters are entered into a database system. The administrative tool 44 defines the number of events that comprise the tour, the starting and ending dates for each of the events, and the prize structure. A tour can have any number of events and each event can have a variable number of rounds.

In a golf game, the tour is scheduled over several months with events scheduled in shorter periods within the tour. The dates and times of the events are announced to participants in the Time Table area 18 of the site. The participants may play the rounds at anytime during the event, in any order, as long as they finish their rounds by the close of the event. The predetermined ranking system and prize table dictates that prizes are distributed to the highest ranked players in each individual event (for example, $500 to the first place player, $300 to the second place player and $50 to the third place player, and so on).

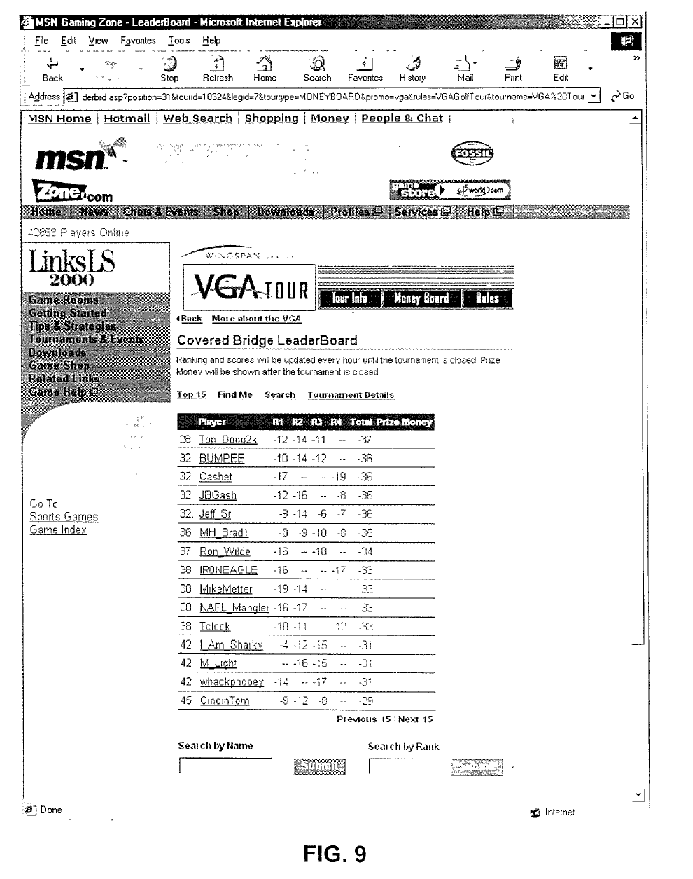

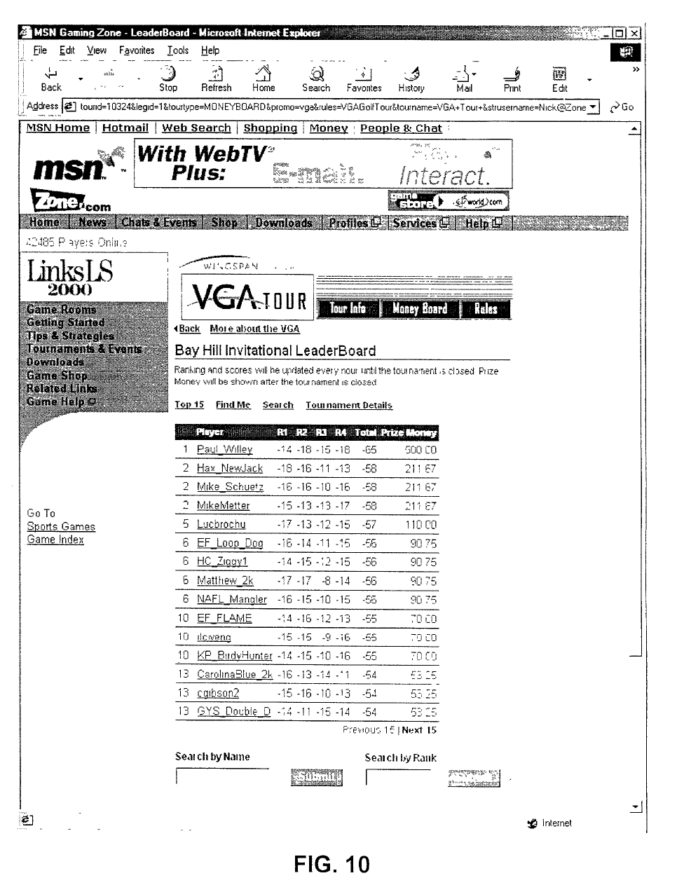

Since each event in the tour has predefined start and end times, the system displays only those rounds which are available for the participant at the time they enter the site. The player goes to a defined location on the Tour Home 10, the game room or “lobby” to join other participants and launch a round. Using a technique called ‘Pre-set launch mode,’ the web server 40 communicates the correct parameters for the round to the user's computer 38 to ensure that everyone who plays the round is competing under the same conditions. The Pre-set launch locks parameters such as weather conditions, gimmies, and the skill level of the round. When the round is over, the scores of the players from the round are automatically uploaded to the web server 40 and stored in a database. As the event progresses, the results of the rounds are collected and displayed in web pages in a leader board format for viewing by all players, FIG. 9. The collected scores are sorted and posted on a leader board which indicates the standings for the event. The leaderboard is updated frequently so the participants can gauge their performances and the performances of their rivals. Once an event is closed, that is, the event time expires, the results of all of the rounds in the event are collected and processed. The players are ranked for the last time and the system correlates the top n winners of the event to a predefined prize structure such as points or money, FIG. 10. In the event of a tie for a position, the points or prize money for all people in a tie for the position and subsequent positions which are taken up by the tied players is summed and distributed equally among the tied players.

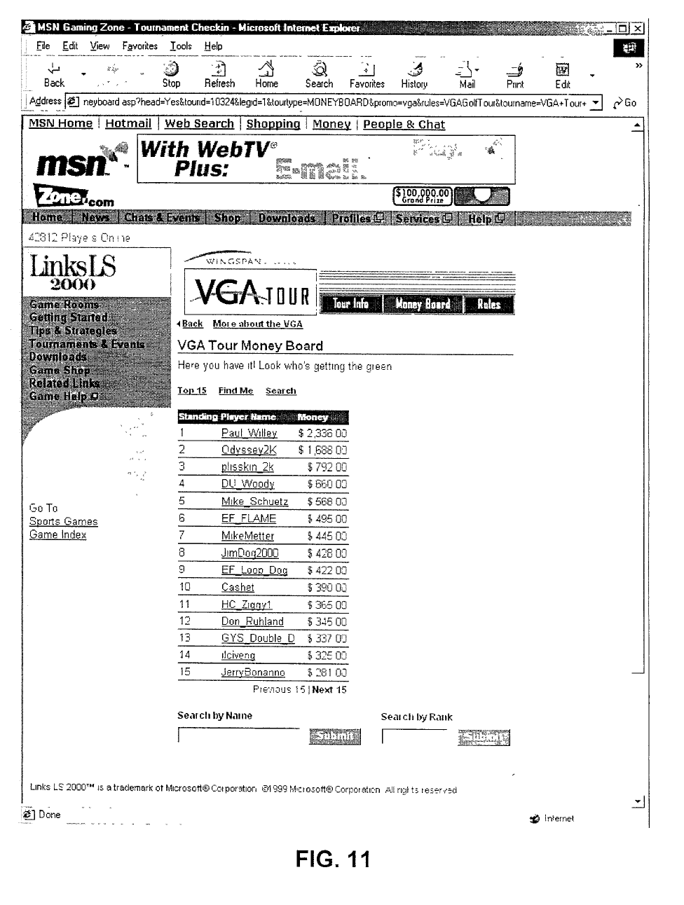

The rankings by score or earnings are added to a master scoreboard or money board and displayed to participants, FIG. 11. If a player who ranks in an individual event is already ranked on the master scoreboard, the points or prize money they have just won is added to their total on the board. Players not already on the board are added for the first time along with their first point or prize money total. The master scoreboard is sorted and the results displayed. The type of sort operation depends on the sport or game and whether points or dollar figures are used for ranking. For example, in a point or money earnings system in which the highest total is the top player, the sort would be in descending order. If the master scoreboard was used to display points instead of money earnings, as opposed to a golf competition point system in which the lowest score is the winner, the sort would be in ascending order. The master scoreboard or money board is updated at the end of each event so that participants can gauge their performances. At the completion of a tour or season, the master scoreboard or money board indicates the top players on the tour. The top n places on the master scoreboard may also be eligible to win additional prizes or compete in further finalist competitions.

An advantage of a competition with a master scoreboard is that players do not need to enter every event, they can choose those which are interesting to them or are most conveniently scheduled. This gives players the chance to win overall even without entering every event. Because of this fact, it is possible to start competing in a tour even after it has begun, the players need not keep precise track of when tours begin or even know the precise schedule. In addition, players do not have to play the rounds in any particular order, as long as all of the rounds are completed in the event period their results will be recorded.

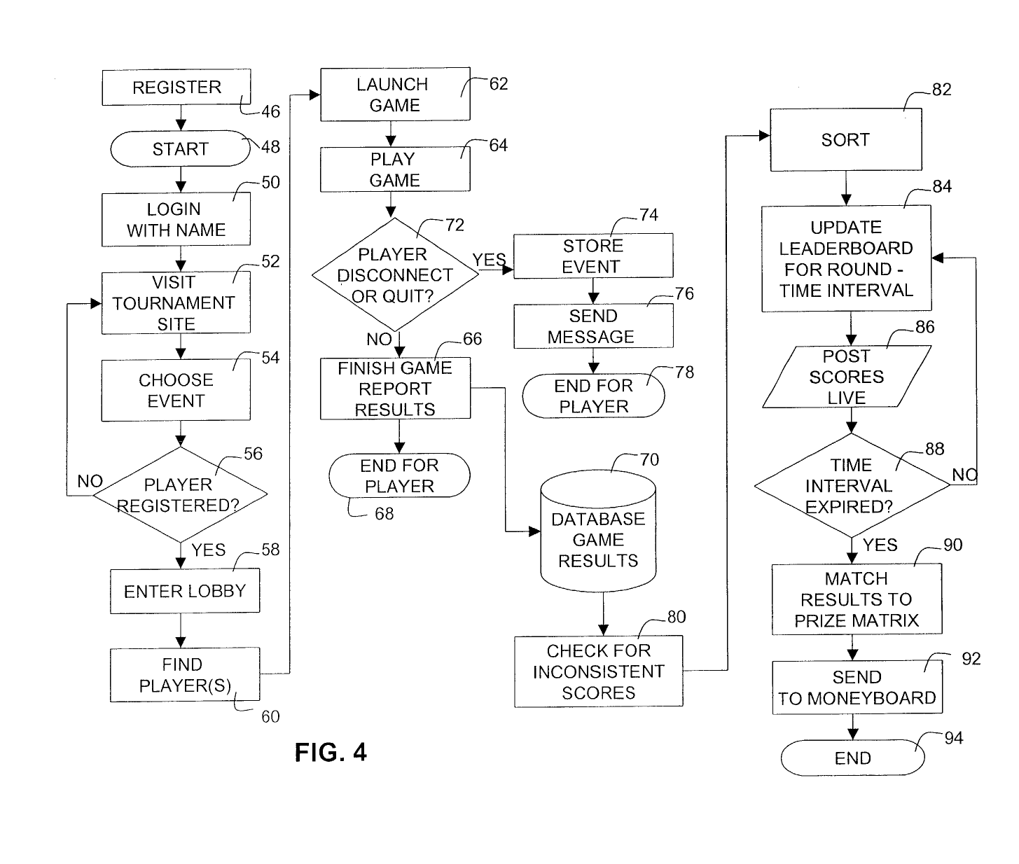

With reference to FIGS. 4-11, the play of a representative participant through the competition will be described. This description is based on a golf competition in which the users have the MS Links LS 2000™ golf game software on their computers, and have Internet access. The Tour Home 10 is designed to interface with the game software resident on the users' computers. The Tour Home 10 is reached by accessing the Microsoft gaming site known as the “Zone” (http://zone.msn.com), and progressing through the “sports” and “Links LS 2000” selections. While the competition described in detail is based on golf, it will be understood that the principles of the invention can be applied to a variety of sports and games that can be played on a computer.

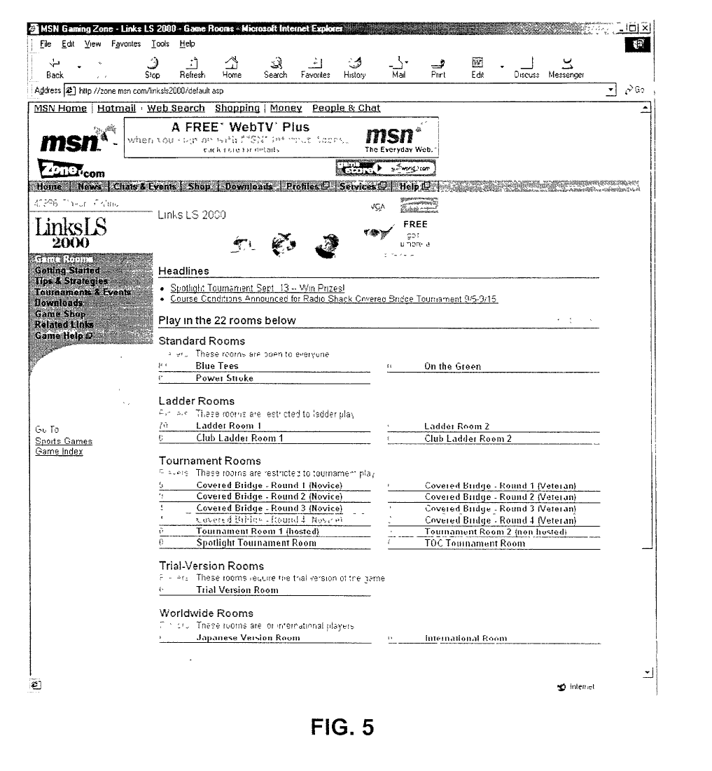

A number of tours are available on the Zone gaming site, and each of the tours is comprised of tournaments or events as described herein. Each tour is described herein as play on a Tour Home, and a player's travel through a Tour Site as well as other processing steps are illustrated in FIG. 4. The reference numerals for the processing steps are shown parenthetically. After accessing the Tour Site a first time player would have had to register (46) through the standard Zone signup and create a login name and password. The Tour Site recognizes user names and passwords created at the Zone. The player registration information is stored in a database administered by the administrative web server 44. After registration, a player can start (48) by logging in with the login name and password (50) and enter the Tournament site (52), FIGS. 1 and 5.

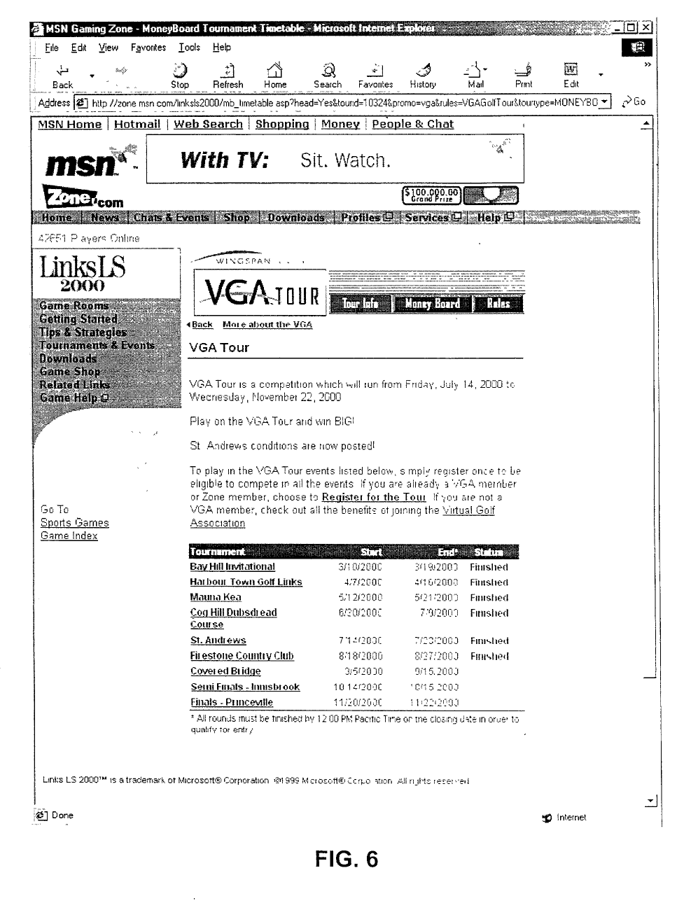

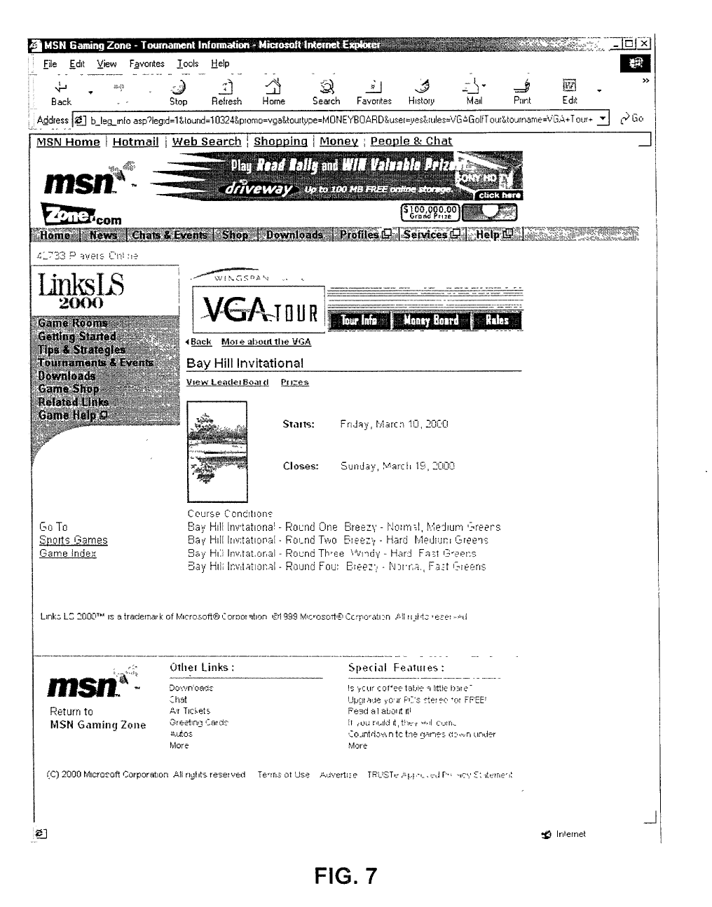

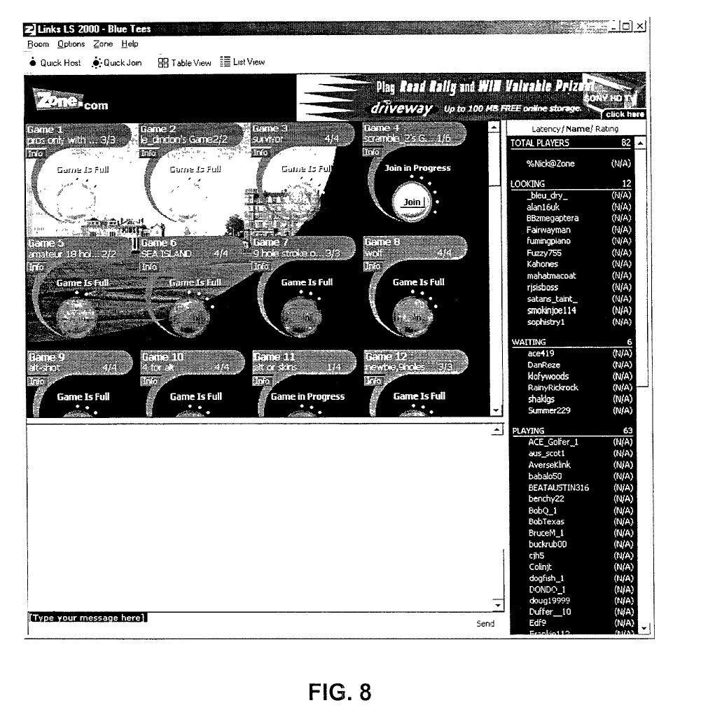

A list of tournaments or events comprising the tour is shown in the Competition Information area, FIG. 6. The list of events includes a status line which informs the player of whether the event is finished, that is, closed due to time expiration, and whether any events are available for play. A summary page for the event, FIG. 7, is available which describes the start and end dates and times, and the conditions for each of the rounds. A player may play in the rounds in any order, as long as they are completed by the event close date. The player selects the event from the listing (54), FIG. 5. Upon selection of an event, the SQL server 42 checks to confirm the player's registration (56), FIG. 4, and if any problem is identified with the player, the player is placed back at the Tournament site, FIG. 5. Assuming no registration problems, the player is allowed into the lobby, FIG. 8.

From the lobby, the player can then review a list of “rooms” representing tournaments or events that are scheduled to take place during the tour. A number of rooms such as the standard rooms, ladder rooms and trial version rooms are for practice or other types of play. In order to participate in the tour, the player selects the “Tournament Rooms,” FIG. 5, and the player is presented with a number of games in the lobby, FIG. 8. The player is then presented with on-going and available “games” for the round. The particular game that is illustrated requires that a minimum of two players play a round together, so the player must join another player or group (60). Once a group of players have joined a game, they launch the game (62) and play their round (64). When the game is finished (66), the round is finished for the player (68), FIG. 4. The results of the completed game are reported (66) to the SQL server 42 (70) which collects the results of all games in the round and ranks the players by score.

While a player may play a round multiple times, only their first complete score for a round will be recorded for purposes of the tournament. This prevents a player from “practicing” and posting a score they select, thus enhancing the real-life feel of the tour. In addition, another aspect of keeping the tour as genuine a competition as possible is the system's ability to disqualify players. If during play, any of the players quits or disconnects (72), that event is stored (74) with the player's information in the SQL server. A history of disconnects is maintained in the SQL server. The administrative web server 44 can pull data from the SQL server to view whether a particular player has a history of disconnects during play which may reveal a tendency to quit while they are behind to avoid having a poor score recorded. If such a tendency is detected, a player may be automatically disqualified by the SQL server. Players may not be notified of such automatically generated disqualifications, but a player can be informed of their disqualification from the tour (76) signaling the end of play (78) for the player. While the administrative web server 44 may allow their login in the future, such a player will not be able to get any points. The administrative web server 44 also checks for multiple registrations by the same player and multiple appearances by one player under different login identities. Only the administrator can disqualify a player from an entire event, and the administrator may tailor a set of circumstances to disqualify players.

When a player finishes a game (66) their score for the round is reported to a database (70). The system reports the scores for the game and the system checks for any scoring inconsistencies (80). The scores are then sorted (82) as described above to rank all the players participating in a round. The scores are automatically uploaded and processed at regular intervals on the LeaderBoard (84), and the progress of players in any event can be viewed on the LeaderBoard, FIG. 9. The LeaderBoard in FIG. 9 lists scores for an event that is ongoing (86) as is apparent from the blanks in some of the players' scores for the rounds, and the fact that the “prize money” column is unpopulated.

Once an event is completed (88), all of the scores of players who have completed all the rounds are sorted and ranked (82). The final rankings for the event are correlated to a predetermined prize matrix (90), and prize money amounts awarded to the players. A LeaderBoard for a completed event is represented in FIG. 10 with all of the scores of all rounds and the prize money column completed. As explained above, the tied players' prize money is calculated by summing the prize money corresponding to all of the tied positions and distributing portions equally among the tied players. For example, in FIG. 10, there is a three-way tie for second place and those players occupy positions two, three and four on the LeaderBoard. The prize money that would have been awarded to places two, three and four is summed and then split evenly three ways among the tied players.

The results of the event LeaderBoard are automatically uploaded to the master scoreboard for tallying of a total, or Money Board (92) in this particular golf competition. The Money Board is updated and the players ranked by their total prize money winning, and for this player in this round, the process is completed (94). The rankings are displayed as represented in FIG. 11. It can be seen that a player need not compete in every event of a tour to be on the Money Board if they perform well in events that they do enter.

An alternative path that a player may take through the Site is to review the Tournaments, FIG. 6, and then step through the screens of any one Tournament, FIGS. 7, 9, 10, to keep themselves apprised of the play conditions, standings, scores, etc.

To entice the participants even further, the competition may be set up to award bonus prize money to the top n finishers on the Money Board at the end of a tour or season. Additionally a championship competition may be set up to enable the top n finishers on the Money Board at the end of a tour or season to compete head-to-head in a play-off for more prizes.

The competition described heretofore has been described as taking place online via the Internet. The invention is contemplated to be used with a variety of configurations such as allowing the games to occur offline and having the results uploaded by any type of connectivity to a site or an administrator.

The foregoing explanation includes many variations and embodiments, and the invention is not intended to be limited to the specific details disclosed herein, but only by the claims appended hereto.

1. A method for conducting an online computer game competition comprising a plurality of events each of which comprises at least one game with updates of results comprising:
hosting a plurality of games in an event for play by individual players;
enabling individual scores to be posted anytime between specified time periods;
collating the scores of the games at regular intervals;
generating a ranking of participants in the games by sorting the collected scores; and
displaying the game score rankings to enable tracking of players' progress.

2. The method of claim 1, further comprising the steps of:
collecting the game score rankings of completed games for each event; and
generating a final event ranking by sorting all of the game score rankings.

3. The method of claim 2, further comprising the steps of:
correlating the final event ranking to a predetermined point matrix to determine a master point value for each player according to their final event ranking.

4. The method of claim 3, further comprising the steps of:
ranking the master point values of all players to generate a master scoreboard for the entire competition.

5. The method of claim 4, wherein top ranked players in a final ranking on the master scoreboard at the completion of the competition qualify for prizes.

6. The method of claim 4, wherein top ranked players in a final ranking on the master scoreboard at the completion of the competition qualify for playoff competition.

7. The method of claim 2, further comprising the steps of:
correlating the final event ranking to a predetermined prize matrix to determine a prize money value for each player according to their final event ranking.

8. The method of claim 7, further comprising the steps of:
ranking the prize money values of all players to generate a master money board for the entire competition.

9. The method of claim 8, wherein top ranked players in a final ranking on the master money board at the completion of the competition qualify for prizes.

10. The method of claim 8, wherein top ranked players in a final ranking on the master money board at the completion of the competition qualify for playoff competition.

11. The method of claim 1, further comprising the steps of:
requiring player registration information for participation in the competition; and
authenticating players' registration information with data stored in a database.

12. The method of claim 11, further comprising the step of:
determining whether a player's play history in the competition should disqualify the player for further participation.

13. A method of generating a master scoreboard for an online competition comprising a plurality of events each of which comprises a plurality of games played by individual participants, said method comprising:
assigning point values to a winning event total and a number of runners up for each event;
recording the results of all games into a database;
summing the recorded results of all the games to determine an event total for each player;
ranking players for each event according to their event totals;
correlating the point values to players by their event totals;
generating a master scoreboard value by adding each player's point value to an existing point value for the player;
sorting the master scoreboard values in an order appropriate for the competition; and
ranking players by their master scoreboard values.

14. The method of claim 13, further comprising a step of resolving tied event totals by summing point values for the event ranking for the tied players and evenly dividing among the tied players to determine a resolved point value.

15. A system for generating a master scoreboard for an online competition comprising a plurality of events each of which comprises a plurality of games played by individual participants, said system comprising:
a web server for communication with individual computers for managing a plurality of games and events;
a first database and processor in communication with said web server for storing and processing data collected from the games and events;
an administrative server in communication with said web server for administering game and event information; and
a second database in communication with said administrative server for storing game and event information and player registration information.

16. A computer game competition comprising:
a plurality of tournaments, each tournament comprising plurality of games in which individual players participate;
a games results board listing rankings of players in each of the games;
a tournament results board listing rankings of players who have completed a tournament; and
a master scoreboard listing rankings of players based on their tournament results.

17. The computer game competition of claim 16, wherein said games results board is generated by automatic upload and sorting of games data.

18. The computer game competition of claim 16, wherein said tournament results board is generated by automatic upload and sorting of tournament data.

19. The computer game competition of claim 16, wherein said master scoreboard is generated by automatic upload and sorting of tournament data correlated to a point matrix.

20. The computer game competition of claim 16, wherein said games results board is updated real-time on a regular basis as the games progress.
